(19) United States
(12) Patent Application Publication
(10) Pub. No.: US 2003/0087630 A1
(43) Pub. Date: May 8, 2003

(54) Method of searching for electronic mail in portable cellular phone and electronic mail searching program for portable cellular phone

(75) Inventor: Satoru Wakabayashi, Tokyo (JP)

Correspondence Address: Paul-J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/288,904

(22) Filed: Nov. 6, 2002

(30) Foreign Application Priority Data
Nov. 6, 2001 (JP) 2001-341282

(51) Int. Cl. H04Q 7/20; H04M 11/00; H04M 11/10

(52) U.S. Cl. 455/412; 455/403

(57) ABSTRACT

A method of searching for an e-mail (electronic mail) is provided which is capable of performing a search on all pieces of e-mail for a specified character string or a graphical character (icon) in a portable cellular phone within a short time and in a reliable manner. The method employed in the portable cellular phone having a function of transmitting and receiving e-mail includes steps of storing transmitted and received e-mail in an e-mail storing area, of having an e-mail searching block perform a search around the e-mail storing area for at least one desired e-mail by a specified character string or a specified graphical color representing the graphical character contained in the e-mail and of displaying one line containing the specified character string or the graphical character existing in detected e-mail on a screen of a displaying device and displaying, when any one line is selected from various pieces of one line being displayed, a whole content in the e-mail containing the one line on the screen of the displaying device.

### BACKGROUND OF THE INVENTION

1. Field of the Invention

The present invention relates to a method of searching for e-mail containing a specified character string or a specified graphical character (icon) from e-mail being stored in a portable cellular phone and an e-mail searching program to be used in the portable cellular phone.

The present application claims priority of Japanese Patent Application No. 2001-341282 filed on Nov. 6, 2001, which is hereby incorporated by reference.

2. Description of the Related Art

In recent years, a portable cellular phone having a function of transmitting and receiving e-mail is widely used. Such the portable cellular phone provided with the e-mail transmitting and receiving function has made a remarkable progress, which enables a user to store many pieces of e-mail in the portable cellular phone and allows a significantly large number of characters to be transmitted or received by one time operation.

When the user of such the portable cellular phone has to search for e-mail containing a specified content from many pieces of e-mail being accumulated in a portable cellular phone e-mail storing area, a method is conventionally employed in which only subjects of each piece of e-mail are first displayed on a display portion of the portable cellular phone and then one of the subjects presumed to be corresponding to the specified content is selected and further contents of the e-mail having the selected subject are sequentially read, thus enabling e-mail having a desired content to be found.

However, such the conventional method presents a problem in that a long time is required for searching for e-mail having the specified content because the subject presumed to be corresponding to the specified content has to be selected first and then contents of e-mail containing the selected subject have to be read.

Moreover, the conventional method presents another problem in that, when the user makes a check of whether or not the selected e-mail has the desired content, if the user searches for email that the user has read in the past, in order to make a checking in a short time, a search is performed by a so-called “oblique reading” in many cases and, therefore, the user overlooks the specified content and, as a result, fails to find the desired e-mail having the desired content.

### SUMMARY OF THE INVENTION

In view of the above, it is an object of the present invention to provide a method of searching for e-mail which enables e-mail having a specified content to be detected from many pieces of e-mail being stored in a portable cellular phone within a short time and in a reliable manner and an e-mail searching program for the portable cellular phone.

According to a first aspect of the present invention, there is provided a method of searching for an electronic mail in a portable cellular phone including an electronic mail storing device, an electronic mail searcher, a displaying device, and an electronic mail transmitter/receiver for transmitting and receiving an electronic mail, the method including:

a step of storing the transmitted or received electronic mail in the electronic mail storing device;

a step of having the electronic mail searcher perform a search around the electronic mail storing device for a specified electronic mail by a specified character string contained in the specified electronic mail; and

a step of displaying one line containing the specified character string in the specified electronic mail obtained by the search on a screen of the displaying device.

In the foregoing first aspect, a preferable mode is one that wherein further includes a step of performing a search around a subject, a text, or both the subject and the text of each of all electronic mails being stored in the electronic mail storing device for the specified electronic mail by the specified character string.

Another preferable mode is one that wherein further includes a step of performing a search around a folder being currently accessed, all folders, or a specified folder for the specified electronic mail by the specified character string.

Still another preferable mode is one that further includes a step of displaying, in a case respective one lines containing the specified character string in a plurality of the specified electronic mails obtained by the search are displayed on a screen of the displaying device, when an arbitrary one line is selected from a plurality of the one lines being displayed, a whole content of the electronic mail corresponding to the selected one line on the screen of the displaying device of the portable cellular phone.

According to a second aspect of the present invention, there is provided a method of searching for an electronic mail in a portable cellular phone including an electronic mail storing device, an electronic mail searcher, a displaying device, and an electronic mail transmitter/receiver for transmitting and receiving an electronic mail containing a graphical character, the method including:

a step of storing the transmitted or received electronic mail in the electronic mail storing device;

a step of having the electronic mail searcher perform a search around the electronic mail storing device for a specified electronic mail by a graphic color making up a specified graphical character string contained in the specified electronic mail; and

a step of displaying one line containing the specified graphical character in the specified electronic mail obtained by the search on a screen of the displaying device.

In the foregoing second aspect, a preferable mode is one that wherein further includes a step of performing a search around a subject, a text, or both the subject and the text of each of all electronic mails being stored in the electronic mail storing device for the specified electronic mail by the graphic color making up the specified graphical character string.

Another preferable mode is one that wherein still further includes a step of performing a search around a folder being currently accessed, all folders, or a specified folder for the specified electronic mail by the graphic color making up the specified graphical character string.

Still another preferable mode is one that wherein further includes a step of displaying, in a case respective one lines containing the specified character string in a plurality of the specified electronic mails obtained by the search are displayed on a screen of the displaying device, when an arbitrary one line is selected from a plurality of the one lines being displayed, a whole content of the electronic mail corresponding to the selected one line on the screen of the displaying device of the portable cellular phone.

According to a third aspect of the present invention, there is provided an electronic mail searching program for having a computer perform processing in a portable cellular phone having a function of transmitting and receiving electronic mail, wherein the processing contains steps of storing transmitted and received electronic mail in an electronic mail storing device, of performing a search around subjects, texts, or both the subjects and the texts contained in all electronic mails being stored in a folder being currently accessed, in all folders, or in a specified folder in the electronic mail storing device for desired electronic mails by a specified character string contained in the transmitted or received the electronic mail and of displaying all pieces of one line containing respectively the specified character string in the desired electronic mails obtained by the search on a screen of a displaying device of the portable cellular phone and of displaying, when any one line is selected from the all pieces of one line being displayed, a whole content containing the selected one line on the screen of the displaying device of the portable cellular phone.

According to a fourth aspect of the present invention, there is provided an electronic mail searching program for having a computer perform processing in a portable cellular phone having a function of transmitting and receiving electronic mail containing a graphical character, wherein the processing contains steps of storing the transmitted and received electronic mail in an electronic mail storing device, of performing a search around subjects, texts, or both the subjects and the texts contained in all electronic mails being stored in a folder being currently accessed, in all folders, or in a specified folder in the electronic mail storing device for desired electronic mails by a graphical color making up a specified graphical character contained in the transmitted or received electronic mail and of displaying all pieces of one line containing respectively the specified graphical character in the desired electronic mails obtained by the search on a screen of the displaying device of the portable cellular phone and then displaying, when any one line is selected from the all pieces of one line being displayed, a whole content containing the one line on the screen of the displaying device of the portable cellular phone.

According to a fifth aspect of the present invention, there is provided a storage medium storing the electronic mail searching program as stated in the third and fourth aspects and being readable by a computer.

With the above configuration, by performing a search on e-mail being stored in the portable cellular phone for a graphical color making up a specified graphical character, all pieces of the e-mail containing the designated graphical character can be found for within a short time and in a reliable manner.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing configurations of a portable cellular phone in which a method of searching for e-mail in the portable cellular phone of a first embodiment of the present invention is applied;

FIG. 2 is a flowchart showing e-mail searching processes in the portable cellular phone according to the first embodiment of the present invention; and

FIG. 3 shows a particular example of configurations of a terminal to execute the method of searching for the e-mail according to the first embodiment of the present invention;

### DETAILED DESCRIPTION OF THE PREFERRED EMBODIMENTS

Best modes of carrying out the present invention will be described in further detail using various embodiments with reference to the accompanying drawings.

### First Embodiment

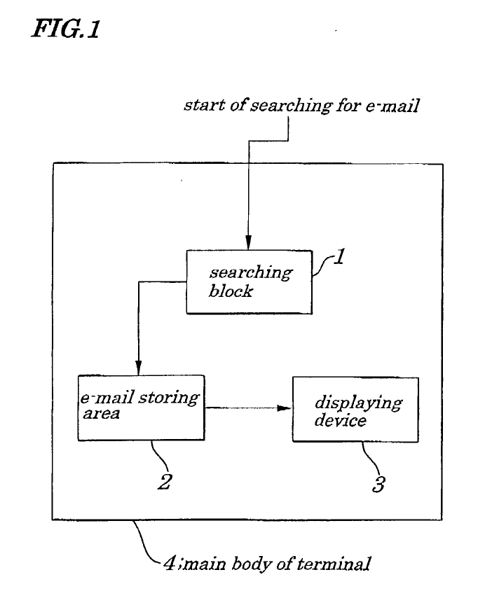

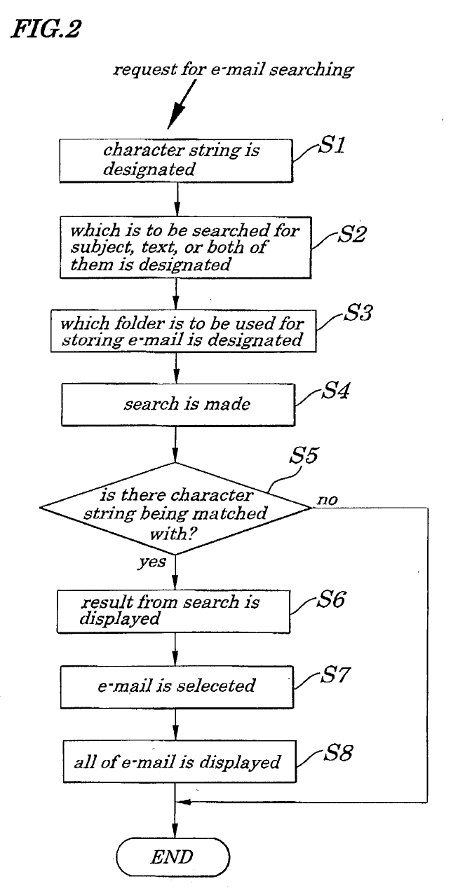

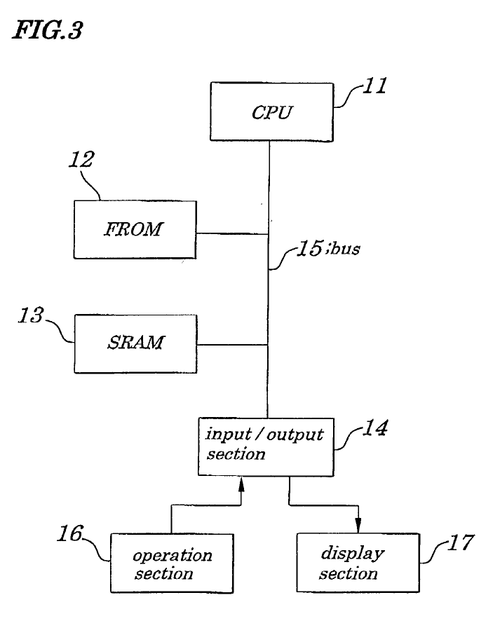

FIG. 1 is a schematic block diagram for showing configurations of a portable cellular phone in which a method of searching for e-mail of the portable cellular phone of a first embodiment of the present invention is applied. FIG. 2 is a flowchart showing e-mail searching processes in the portable cellular phone according to the first embodiment. FIG. 3 shows a particular example of configurations of a terminal to execute a method for searching for the e-mail according to the first embodiment.

A terminal of the portable cellular phone in which the method of searching for the e-mail being stored in the portable cellular phone chiefly includes a searching block 1, an e-mail storing area 2, and a displaying device 3, all of which are housed in a main body 4 of the terminal of the portable cellular phone. The searching block 1, in accordance with an instruction from a user, searches for e-mail containing a specified character string being stored in the e-mail storing area 2 and reads one line containing the specified character string contained in the e-mail and finds a whole content of e-mail containing the specified character string. The e-mail storing area 2 stores a plurality of pieces of e-mail in one or a plurality of folders. The displaying device 3 is made up of, for example, a liquid crystal display (LCD) and displays a telephone number, various messages or a like on its screen in a visual form and displays one line containing the specified character string of e-mail output from the e-mail storing area 2 or all characters of the e-mail containing the specified character string.

Next, the method of searching for the e-mail in the portable cellular phone of the embodiment is described by referring to FIG. 1. When a user designates a specified character string contained in e-mail and designates subjects, texts, or both the subjects and texts of the e-mail as an object containing the specified character string to be searched for and further designates a folder being currently accessed, all folders, or a specified folder as the folder storing e-mail containing the specified character string, the searching block 1, in accordance with an instruction, performs a search on the e-mail storing area 2 and checks as to whether or not e-mail containing a specified character string exists in the subjects, the texts, or both the subjects and the texts contained in the e-mail in a designated folder in the mail storing area 2 and, if there exists e-mail containing the designated specified character string, performs processing of having the displaying device 3 output one line containing the specified character string designated in the e-mail on all pieces of the e-mail stored in the designated folder and, the displaying device 3 displays the specified one line for all pieces of the e-mail as a result from the search.

Then, when the user selects, based on results from the search, any one line being displayed on the displaying device 3 through the searching block 1, the searching block 1 performs processing of having the displaying device 3 output a whole content containing the one line out of the email storing area 2, which enables all the selected contents of the e-mail to be displayed on the displaying device 3. By processing performed by the user on all pieces of the one line containing the specified character string being displayed on the displaying device 3, contents of all pieces of the e-mail containing the specified character string can be viewed and read.

A flow of processing employed in the e-mail searching method is explained by referring to FIG. 1 and FIG. 2. In order to search for the desired e-mail in accordance with an e-mail searching request, a specified character string is input into the searching block 1 (Step S1), subjects, texts, or both the subject and the texts are designated as objects on which a search is to be performed (Step S2). A folder being currently accessed, all the folders, or a specified folder are designated as folders storing e-mail and as objects on which the search is to be performed (Step S3).

This causes the searching block 1 to check whether or not the designated character string is contained in any one of the subjects the text, and both the subject and the text of an e-mail being stored in the designated folder in the e-mail storing area 2 (Step S4). Here, if there is not located the designated character string, the processing is terminated. However, if the designated character string is located (Step S5), one line containing the character string in the e-mail is displayed on the displaying device 3 (Step S6). By performing such the processing on all pieces of the e-mail being stored in the designated folder, all pieces of the one line, containing respectively the specified character string, are displayed on the displaying devices 3.

When any of specified one line being displayed on the displaying device 3 is selected to choose an e-mail containing the one line through the searching block 1 (Step S7), the searching block 1 reads a whole content of the corresponding e-mail from the e-mail storing area 2 and has them displayed on the displaying device 3 (Step S8). This enables a user to view and read a whole content of the e-mail containing the specified character string on the displaying device 3.

When viewing and reading of a whole content of the e-mail containing the specified character string is terminated, by having all pieces of the one line, containing respectively the specified character string, again displayed on the displaying device 3 and by selecting a subsequent one line containing the specified character string through the searching block 1, the e-mail containing the one line is designated and a whole content of the corresponding e-mail are read and displayed on the displaying device 3. By repeating such the processing, a whole content of all pieces of the email containing the specified character string can be viewed and read.

Next, a concrete example of configurations of a terminal used to execute a method of searching for e-mail in a portable cellular phone of the first embodiment is described by referring to FIG. 3. The terminal used to perform the method of searching for the e-mail of the portable cellular phone of the embodiment, as shown in FIG. 3, is made up of, for example, a CPU (Central Processing Unit) 11, a FROM (Flash Read Only Memory) 12, an SRAM (Static Random Access Memory) 13, an input/output section 14, a bus 15, an operation section 16, and a display section 17 including the displaying device 3.

The CPU 11 is adapted to operate in accordance with a program to control execution of the method of searching for the e-mail of the first embodiment. The FROM 12 pre-stores a program to have the CPU 11 operate and stores received e-mail. The SRAM 13 serves as a working region for the CPU 11 to temporarily store data. The input/output section 14 operates to convert an input/output signal to a signal for the bus 15 or vice versa. The bus 15 connects the CPU 11 to each of the components in the terminal. The operation section 16 is provided with a required number of press buttons, keys (all not shown), or a like and, by manipulating these components, inputs instructions from an user into the CPU 11 through the input/output section 14. The display section 17, in accordance with an instruction fed from the CPU 11 through the input/output section 14, displays information about an operation state of the terminal, a content of the input instruction, or a like by using characters or specified codes and contents of received and transmitted mail in character format.

Functions of the searching block 1 are achieved by operations performed by the CPU 11 based on a program output from the FROM 12 in accordance with instructions fed from the user input through the operation section 16. That is, a specified character string to be searched for is input by the operation section 16 and then subjects, texts, or both the subjects and the texts of the e-mail are designated as objects on which a search is to be performed, and a folder being currently accessed, all folders, or a specified folder are also designated as folders storing e-mail. The CPU 11 operates to locate the e-mail storing area 2 in the FROM 12 and performs a search around subjects, the texts, or both the subjects and the texts of all e-mails being stored in the specified folder in the e-mail storing area 2 for e-mail containing the specified character string. If there exists e-mail containing the specified character string, the CPU 11 performs processing of displaying one line containing the specified character string in the e-mail on the displaying section 17 through the input/output section 14 on all pieces of the e-mail being stored in the specified folder and each one line in all pieces of e-mail containing the designated character string is displayed, as a result from the search, on the displaying section 17.

Furthermore, when the operation section 16 designates the specified one line from a plurality of pieces of one line by, for example, moving a cursor (not shown), the CPU 11, in accordance with an instruction, reads a whole content containing the specified one line from the e-mail storing area 2 in the FROM 12 and displays them on the displaying section 17. By performing such the processing as described above on all pieces of the one line containing the specified character string being displayed on the displaying section 17, it is made possible to view and read a whole content in the e-mail containing the specified character string.

Thus, according to the method of searching for e-mail of the first embodiment, by performing a search on the e-mail being stored in the portable cellular phone for the specified character string, the search for all pieces of the e-mail containing the specified character string can be performed within a short time and in a reliable manner.

### Second Embodiment

A method of searching for a specified e-mail of a second embodiment is described in which specified mail is searched for by designating a graphical color for a graphical character (hereinafter may be referred to as icon) contained in e-mail. Configurations of a portable cellular phone terminal in which the method of searching for the e-mail of the second embodiment is employed and a concrete example of the terminal used to execute the method of searching for the e-mail in the portable cellular phone in the second embodiment are same as employed in the first embodiment shown in FIG. 1 and FIG. 3 and their descriptions are omitted accordingly. Moreover, processing of searching for the e-mail in the portable cellular phone of the second embodiment is approximately same as those shown in a flowchart of FIG. 2 and differs from those in the first embodiment in that, instead of a character string, the graphic color contained in the icon is used.

The portable cellular phone employed in the second embodiment has additional functions of handling the graphical character in a same manner as for a non-colored character and of displaying it on a displaying section 17 and of storing it in an e-mail storing area 2. Each of the icons has its own color. Since the icons can be displayed on a screen of the display device 3, if the icon is to be used in e-mail, by designating a desired icon using a cursor, keys or buttons (not shown) out of various types of icons being displayed on the screen, the desired icon can be incorporated into a content of the e-mail. In this case, following processing is performed within the terminal; that is, by designating the specified icon using the cursor, the specified code representing the above icon, instead of a character code, is inserted into data representing the e-mail. The code representing the icon is made up of a code representing a pattern of the icon and a code indicating a graphical color making up the icon. Thus, by using such the function of using icons, a part of or an entire of the e-mail can be expressed by icons, which enables a characteristic expression to be provided to the e-mail.

When e-mail using icons that has been sent or received by the portable cellular phone is to be searched for, unlike in the case of the first embodiment, though it is impossible to make a search by using a character string, e-mail containing the designated icon can be searched for by designating a graphical color given to the icon. More particularly, when a code for a graphical color being a part of codes representing the icons is input from an operation section 16, a CPU 11 makes a search for each piece of e-mail containing the icon having the graphical color and displays specified one line containing the icon in each piece of e-mail on the displaying section 17. When the specified one line is designated by the operation section 16 out of various pieces of one line being displayed, the CPU 11, in accordance with an instruction, reads a whole content in e-mail containing the one line from the e-mail storing area 2 in a FROM 12 and has them displayed on the screen of the display section 17. By performing such the processing on all pieces of the one line containing specified icons being displayed on the display section 17, a whole content making up contents of the e-mail containing the specified icons can be viewed and read.

Thus, according to the method of searching for the e-mail in the portable cellular phone of the second embodiment, by performing the search for the e-mail being stored in the portable cellular phone by the graphical color representing the specified icon, all pieces of the e-mail containing designated icons can be found for within a short time and in a reliable manner.

It is apparent that the present invention is not limited to the above embodiments but may be changed and modified without departing from the scope and spirit of the invention. For example, when the portable cellular phone is powered OFF, if received e-mail is allowed to be erased, the e-mail can be stored in an SRAM 13. Moreover, in the second embodiment, if the icon is represented by one code even having information about the graphical color, the search of the e-mail can be made by designating a code of the icon containing the graphical color. Also, the method of searching for the e-mail in the portable cellular phone of the present invention can be applied to an e-mail search operation to be performed not only by the portable cellular phone but also by a personal computer. Furthermore, as the displaying section 17, not only the liquid crystal display but also an organic electroluminescent panel can be used.

It is apparent that the present invention is not limited to the above embodiments but may be changed and modified without departing from the scope and spirit of the invention.

What is claimed is:

1. A method of searching for an electronic mail in a portable cellular phone including an electronic mail storing device, an electronic mail searcher, a displaying device, and an electronic mail transmitter/receiver for transmitting and receiving an electronic mail, said method comprising:
a step of storing the transmitted or received electronic mail in said electronic mail storing device;
a step of having said electronic mail searcher perform a search around said electronic mail storing device for a specified electronic mail by a specified character string contained in said specified electronic mail; and
a step of displaying one line containing said specified character string in said specified electronic mail obtained by said search on a screen of said displaying device.

2. The method of searching for an electronic mail in the portable cellular phone according to claim 1, further comprising a step of performing a search around a subject, a text, or both said subject and said text of each of all electronic mails being stored in said electronic mail storing device for said specified electronic mail by said specified character string.

3. The method of searching for an electronic mail in the portable cellular phone according to claim 1, still further comprising a step of performing a search around a folder being currently accessed, all folders, or a specified folder for said specified electronic mail by said specified character string.

4. The method of searching for an electronic mail in the portable cellular phone according to claim 1, still further comprising a step of displaying, in a case respective one lines containing said specified character string in a plurality of the specified electronic mails obtained by said search are displayed on a screen of said displaying device, when an arbitrary one line is selected from a plurality of the one lines being displayed, a whole content of said electronic mail corresponding to the selected one line on said screen of said displaying device of said portable cellular phone.

5. A method of searching for an electronic mail in a portable cellular phone including an electronic mail storing device, an electronic mail searcher, a displaying device, and an electronic mail transmitter/receiver for transmitting and receiving an electronic mail containing a graphical character, said method comprising:
a step of storing the transmitted or received electronic mail in said electronic mail storing device;
a step of having said electronic mail searcher perform a search around said electronic mail storing device for a specified electronic mail by a graphic color making up a specified graphical character string contained in said specified electronic mail; and
a step of displaying one line containing said specified graphical character in said specified electronic mail obtained by said search on a screen of said displaying device.

6. The method of searching for an electronic mail in the portable cellular phone according to claim 5, further comprising a step of performing a search around a subject, a text, or both said subject and said text of each of all electronic mails being stored in said electronic mail storing device for said specified electronic mail by said graphic color making up said specified graphical character string.

7. The method of searching for an electronic mail in the portable cellular phone according to claim 5, still further comprising a step of performing a search around a folder being currently accessed, all folders, or a specified folder for said specified electronic mail by said graphic color making up said specified graphical character string.

8. The method of searching for an electronic mail in the portable cellular phone according to claim 5, still further comprising a step of displaying, in a case respective one lines containing said specified character string in a plurality of the specified electronic mails obtained by said search are displayed on a screen of said displaying device, when an arbitrary one line is selected from a plurality of the one lines being displayed, a whole content of said electronic mail corresponding to the selected one line on said screen of said displaying device of said portable cellular phone.

9. An electronic mail searching program for having a computer perform processing in a portable cellular phone having a function of transmitting and receiving electronic mail, wherein said processing contains steps of storing transmitted and received electronic mail in an electronic mail storing device, of performing a search around subjects, texts, or both said subjects and said texts contained in all electronic mails being stored in a folder being currently accessed, in all folders, or in a specified folder in said electronic mail storing device for desired electronic mails by a specified character string contained in said transmitted or received said electronic mail and of displaying all pieces of one line containing respectively said specified character string in said desired electronic mails obtained by said search on a screen of a displaying device of said portable cellular phone and of displaying, when any one line is selected from said all pieces of one line being displayed, a whole content containing the selected one line on said screen of said displaying device of said portable cellular phone.

10. An electronic mail searching program for having a computer perform processing in a portable cellular phone having a function of transmitting and receiving electronic mail containing a graphical character, wherein said processing contains steps of storing said transmitted and received electronic mail in an electronic mail storing device, of performing a search around subjects, texts, or both said subjects and said texts contained in all electronic mails being stored in a folder being currently accessed, in all folders, or in a specified folder in said electronic mail storing device for desired electronic mails by a graphical color making up a specified graphical character contained in said transmitted or received electronic mail and of displaying all pieces of one line containing respectively said specified graphical character in said desired electronic mails obtained by said search on a screen of said displaying device of said portable cellular phone and then displaying, when any one line is selected from said all pieces of one line being displayed, a whole content containing said one line on said screen of said displaying device of said portable cellular phone.

11. A storage medium storing the electronic mail searching program and being readable by a computer, said program for having a computer perform processing in a portable cellular phone having a function of transmitting and receiving electronic mail, wherein said processing contains steps of storing transmitted and received electronic mail in an electronic mail storing device, of performing a search around subjects, texts, or both said subjects and said texts contained in all electronic mails being stored in a folder being currently accessed, in all folders, or in a specified folder in said electronic mail storing device for desired electronic mails by a specified character string contained in said transmitted or received said electronic mail and of displaying all pieces of one line containing respectively said specified character string in said desired electronic mails obtained by said search on a screen of a displaying device of said portable cellular phone and of displaying, when any one line is selected from said all pieces of one line being displayed, a whole content containing the selected one line on said screen of said displaying device of said portable cellular phone.

12. A storage medium storing the electronic mail searching program and being readable by a computer, said program for having a computer perform processing in a portable cellular phone having a function of transmitting and receiving electronic mail containing a graphical character, wherein said processing contains steps of storing said transmitted and received electronic mail in an electronic mail storing device, of performing a search around subjects, texts, or both said subjects and said texts contained in all electronic mails being stored in a folder being currently accessed, in all folders, or in a specified folder in said electronic mail storing device for desired electronic mails by a graphical color making up a specified graphical character contained in said transmitted or received electronic mail and of displaying all pieces of one line containing respectively said specified graphical character in said desired electronic mails obtained by said search on a screen of said displaying device of said portable cellular phone and then displaying, when any one line is selected from said all pieces of one line being displayed, a whole content containing said one line on said screen of said displaying device of said portable cellular phone.
